(19) United States
(12) Patent Application Publication
(10) Pub. No.: US 2020/0134645 A1
(43) Pub. Date: Apr. 30, 2020

(54) DEMAND PREDICTION INFORMATION DISPLAY CONTROL METHOD, DISPLAY CONTROL DEVICE, AND NON-TRANSITORY RECORDING MEDIUM STORING DISPLAY CONTROL PROGRAM

(71) Applicants: TOYOTA JIDOSHA KABUSHIKI KAISHA, Toyota-shi (JP); JapanTaxi Co., Ltd., Chiyoda-ku (JP)

(72) Inventors: Daiki KANEICHI, Nissin-shi (JP); Yuichi KOMATSU, Yokohama-shi (JP); Kiichi UETA, Bunkyo-ku (JP)

(73) Assignees: TOYOTA JIDOSHA KABUSHIKI KAISHA, Toyota-shi (JP); JapanTaxi Co., Ltd., Chiyoda-ku (JP)

(21) Appl. No.: 16/666,570

(22) Filed: Oct. 29, 2019

(30) Foreign Application Priority Data
Oct. 31, 2018 (JP) 2018-205049

(51) Int. Cl. G06Q 30/02; G06F 3/0481

(52) U.S. Cl. CPC G06Q 30/0202; G06F 3/04817

(57) ABSTRACT

A demand prediction information display control method according to the present disclosure is a demand prediction information display control method that is executed by a demand prediction information display control device, and includes displaying demand prediction information and an icon indicating a position of a taxi on a map screen in a superimposing manner, setting, to a non-display, an icon corresponding to a taxi with a passenger, and displaying, with a traveling direction of the taxi, an icon corresponding to a taxi with no passenger.

### INCORPORATION BY REFERENCE

The disclosure of Japanese Patent Application No. 2018-205049 filed on Oct. 31, 2018 including the specification, drawings and abstract is incorporated herein by reference in its entirety.

### BACKGROUND

### 1. Technical Field

The present disclosure relates to a demand prediction information display control method, a display control device, and a non-transitory recording medium storing a display control program.

### 2. Description of Related Art

Japanese Unexamined Patent Application Publication No. 2009-009282 (JP 2009-009282 A) describes a technology for predicting a demand for taxi dispatch.

### SUMMARY

According to the technology described in JP 2009-009282 A, since it is not possible to ascertain a state of a taxi other than a subject vehicle, a passenger desiring dispatch cannot be accurately caused to get in a vehicle. For example, a passenger cannot be accurately caused to get in a vehicle since there are a large number of empty taxis in spite of a movement to a high demand area.

The present disclosure provides a demand prediction information display control method capable of accurately causing a passenger desiring dispatch to get in a taxi, a display control device, and a non-transitory recording medium storing a display control program.

A first aspect of the present disclosure relates to a demand prediction information display control method that is executed by a demand prediction information display control device. The demand prediction information display control method includes displaying demand prediction information and an icon indicating a position of a taxi on a map screen in a superimposing manner; setting, to a non-display, an icon corresponding to a taxi with a passenger; and displaying, with a traveling direction of the taxi, an icon corresponding to a taxi with no passenger.

In the demand prediction information display control method according to the first aspect, the demand prediction information display control device may change a display form of the icon corresponding to the taxi with the no passenger according to the number of nearby pedestrians.

A second aspect of the present disclosure relates to a demand prediction information display control device. The demand prediction information display control device includes a memory; and a processor having hardware. The processor is configured to display demand prediction information and an icon indicating a position of a taxi on a map screen in a superimposing manner, set, to a non-display, an icon corresponding to a taxi with a passenger, and display, with a traveling direction of the taxi, an icon corresponding to a taxi with no passenger.

In the demand prediction information display control device according to the second aspect, the processor may be configured to change a display form of the icon corresponding to the taxi with the no passenger according to the number of nearby pedestrians.

A third aspect of the present disclosure relates to a non-transitory recording medium storing a demand prediction information display control program that causes a demand prediction information display control device to execute a process. The process includes displaying demand prediction information and an icon indicating a position of a taxi on a map screen in a superimposing manner; setting, to a non-display, an icon corresponding to a taxi with a passenger, and displaying, with a traveling direction of the taxi, an icon corresponding to a taxi with no passenger.

In the non-transitory recording medium according to the third aspect, the process may include changing a display form of the icon corresponding to the taxi with no passenger according to the number of nearby pedestrians.

According to the aspects of the present disclosure, it is possible to accurately cause a passenger desiring dispatch to get in a taxi.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic view illustrating a configuration of a vehicle dispatch system according to an embodiment;

FIG. 2 is a block diagram illustrating a configuration of a server illustrated in FIG. 1;

FIG. 3 is a block diagram illustrating a configuration of a vehicle illustrated in FIG. 1;

FIG. 4 is a flowchart illustrating a flow of a display control process according to the embodiment;

FIG. 5 is a diagram illustrating a display example of demand prediction information;

FIG. 6A is a diagram illustrating an operation example of a display mode change user interface;

FIG. 6B is a diagram illustrating an operation example of the display mode change user interface; and

FIG. 6C is a diagram illustrating an operation example of the display mode change user interface.

### DETAILED DESCRIPTION OF EMBODIMENTS

Hereinafter, a vehicle dispatch system of an embodiment will be described with reference to the drawings.

Configuration

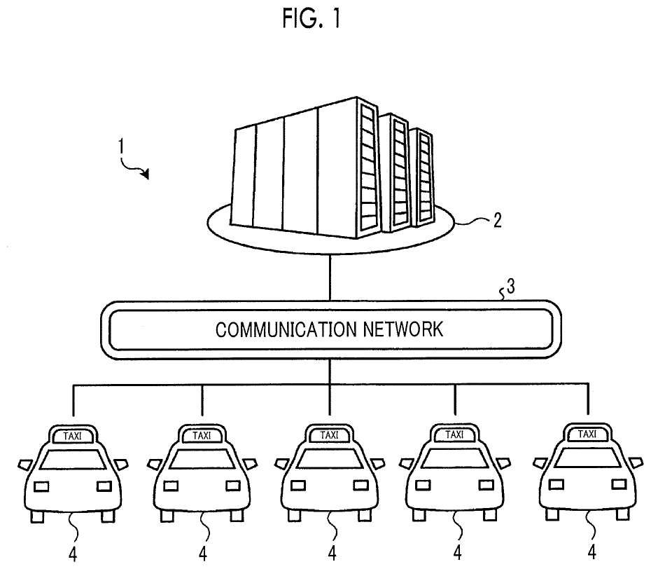

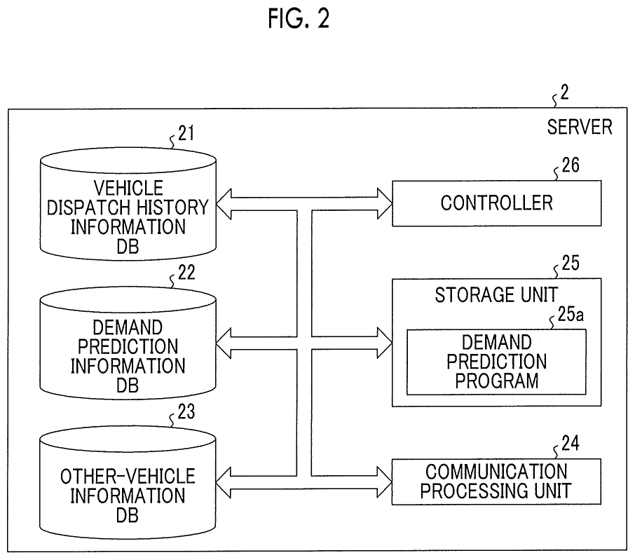

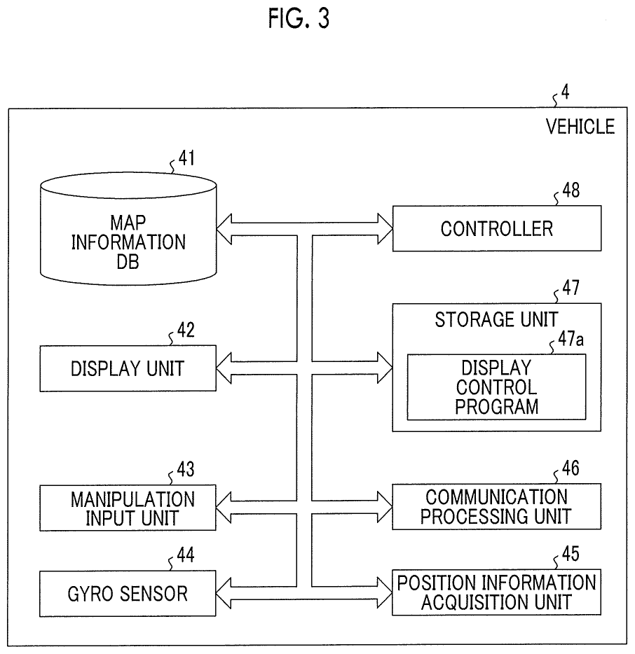

First, a configuration of the vehicle dispatch system of the embodiment will be described with reference to FIGS. 1 to 3. FIG. 1 is a schematic diagram illustrating a configuration of the vehicle dispatch system according to the embodiment. FIG. 2 is a block diagram illustrating a configuration of a server 2 illustrated in FIG. 1. FIG. 3 is a block diagram illustrating a configuration of a taxi 4 illustrated in FIG. 1.

As illustrated in FIG. 1, the vehicle dispatch system 1 according to the embodiment is an information processing system that provides information on demand prediction of taxi dispatch (hereinafter referred to as demand prediction information) to a driver of a taxi such that a taxi can be efficiently dispatched. The vehicle dispatch system 1 includes the server 2 and a plurality of taxis 4 connected to the server 2 via a communication network 3 such as an internet network or a mobile telephone network, as main components.

As illustrated in FIG. 2, the server 2 includes a vehicle dispatch history information database (a vehicle dispatch history information DB) 21, a demand prediction information database (a demand prediction information DB) 22, an other-vehicle information database (an other-vehicle information DB) 23, a communication processing unit 24, a storage unit 25, and a controller 26. The server 2 may include a plurality of computers, or may be a cloud server.

The vehicle dispatch history information DB 21 stores vehicle dispatch history information including information such as a place (including latitude and longitude information, mesh information, information on an administrative division (block area) such as town names or street addresses, and the like) and time in which a dispatch request for the taxi 4 has been made.

The demand prediction information DB 22 stores demand prediction information generated by the controller 26 in a format that can be read via the communication network 3.

The other-vehicle information DB 23 stores information on states (a vacant vehicle, a pick-up vehicle, a rental vehicle, or the like) and positions of the taxis 4, as other-vehicle information. The other-vehicle information stored in the other-vehicle information DB 23 is periodically updated by the server 2 periodically communicating with the taxi 4 to acquire information.

The communication processing unit 24 includes a local area network (LAN) interface board, a wireless communication circuit for wireless communication, or the like. The communication processing unit 24 controls information communication processing with the taxi 4 via the communication network 3.

The storage unit 25 includes a recording medium fixed to a computer or the like, or a recording medium removable from a computer or the like. Examples of the recording medium fixed to a computer or the like may include an erasable programmable ROM (EPROM), and a hard disk drive (HDD). Examples of the recording medium removable from a computer or the like may include a universal serial bus (USB) memory, a flexible disk, a magneto-optical disk, a compact disc-read only memory (CD-ROM), a compact disc-rewritable (CD-RW), a digital versatile disc (DVD), a Blu-ray (registered trademark; BD) disc, a digital audio tape (DAT), a 8 mm tape, and a memory card. A solid state drive (SSD) can also be used as the recording medium removable from the computer or the like or as the recording medium fixed to the computer or the like.

The storage unit 25 stores an operating system, various computer programs, various tables, various databases, and the like. In the embodiment, the storage unit 25 stores a demand prediction program 25a that is a computer program in which a routine for generating demand prediction information has been described or data such as various types of setting information (not illustrated) for generating the demand prediction information. The demand prediction program 25a may be configured to be provided by downloading via the communication network 3.

The controller 26 includes a processor including a central processing unit (CPU), a digital signal processor (DSP), a field-programmable gate array (FPGA), and the like, and a memory (a main storage unit) including a random access memory (RAM) or a read only memory (ROM) (all are not illustrated). The controller 26 loads the computer program stored in the storage unit 25 into a work area of the main storage unit and executes the computer program to control each component or the like through execution of the computer program, thereby realizing a function according to a predetermined purpose. In the embodiment, the controller 26 generates demand prediction information based on the vehicle dispatch history information stored in the vehicle dispatch history information DB 21 by executing the demand prediction program 25a. The controller 26 may generate the demand prediction information also using information such as weather or an event other than the dispatch history information.

As illustrated in FIG. 3, the taxi 4 includes a map information database (a map information DB) 41, a display unit 42, a manipulation input unit 43, a gyro sensor 44, a position information acquisition unit 45, a communication processing unit 46, a storage unit 47, and a controller 48.

A map information DB 41 stores map information. The map information includes information on a position and shape of a road (for example, the number of lanes of the road, types of lanes such as overtaking lanes or traveling lanes), position information on intersections and junctions, information on rivers, waterways, tracks, or the like, and information on administrative divisions such as town names or street addresses. The taxi 4 may be configured to obtain needed map information via the communication network 3 and use the map information.

The display unit 42 includes a display device such as a liquid crystal display device or an organic electro luminescence (EL) display device, and visually displays various types of information according to a display control signal from the controller 48. Although various types of information are visibly displayed in the embodiment, various types of information may be output by voice.

The manipulation input unit 43 includes a manipulation input device such as a keyboard, a touch panel, a switch, and a microphone, and outputs a manipulation input signal indicating manipulation content of the driver to the controller 48 according to a manipulation of the driver of the taxi 4.

The gyro sensor 44 acquires information on a direction of the taxi 4 and outputs a signal indicating the acquired direction of the taxi 4 to the controller 48.

The position information acquisition unit 45 receives GPS signals distributed from three or more global positioning system (GPS) satellites orbiting on an earth orbit, and measures position information of the taxi 4 based on the received GPS signals. The position information acquisition unit 45 outputs an electric signal indicating the measured position information of the taxi 4 to the controller 48.

The communication processing unit 46 includes, for example, a wireless communication circuit for wireless communication. The communication processing unit 46 controls an information communication process with the server 2 via the communication network 3.

The storage unit 47 is configured similar to the storage unit 25 on the server 2 side. The storage unit 47 stores an operating system, various computer programs, various tables, various databases, and the like. In the embodiment, the storage unit 47 stores a display control program 47a that is a computer program in which a routine for displaying and controlling various types of information on the display unit 42 is described or data such as various types of setting information (not illustrated) for displaying and controlling various types of information on the display unit 42. The display control program 47a may be configured to be provided by being downloaded via the communication network 3.

The controller 48 is configured similarly as the controller 26 on the server 2 side. The controller 48 loads the computer program stored in the storage unit 47 into a work area of the main storage unit and executes the computer program to control each component or the like through execution of the computer program, thereby realizing a function according to a predetermined purpose.

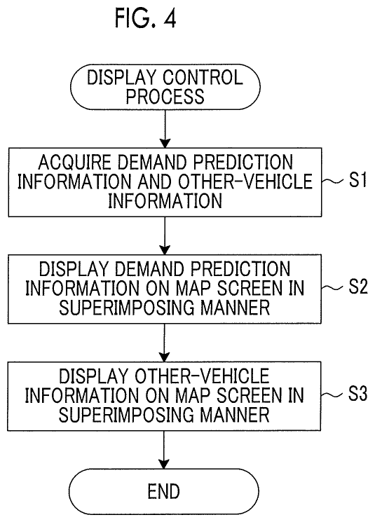

In the vehicle dispatch system 1 having such a configuration, the controller 48 of the taxi 4 executes the display control process to be described below such that the driver of the taxi 4 can accurately cause a passenger desiring dispatch to get in the taxi 4. An operation of the controller 48 when the display control process is executed will be described below with reference to FIGS. 4 to 6A, 6B, and 6C.

Display Control Process

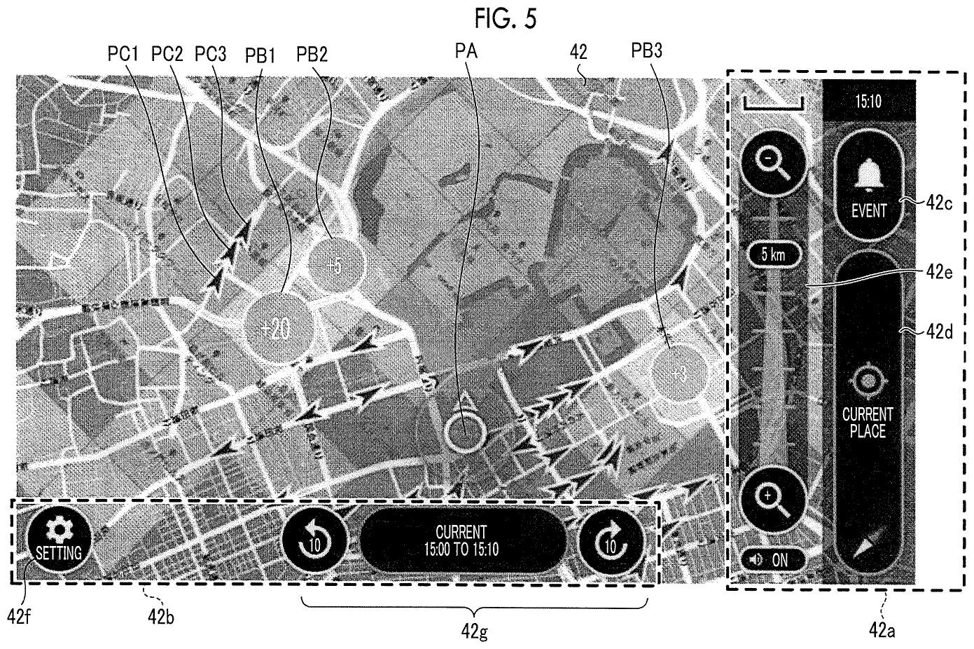

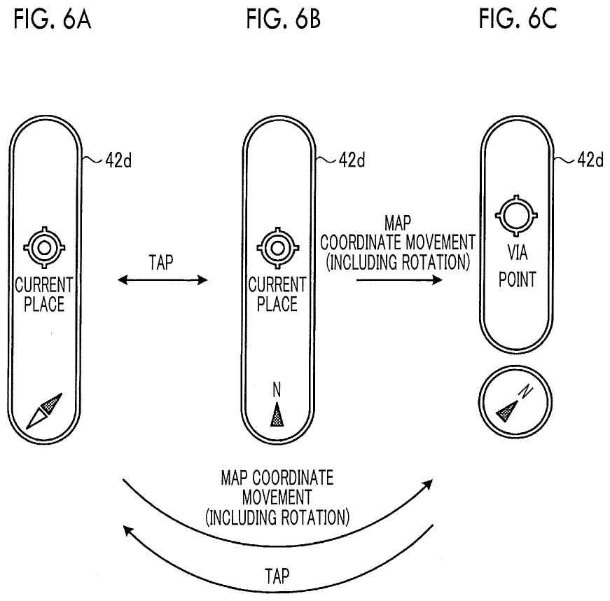

FIG. 4 is a flowchart illustrating a flow of a display control process according to the embodiment. FIG. 5 is a diagram illustrating a display example of the demand prediction information. FIGS. 6A, 6B, and 6C are diagrams illustrating an operation example of the display mode change user interface.

The flowchart illustrated in FIG. 4 starts at a timing when the driver of the taxi 4 instructs the display unit 42 to display the demand prediction information by manipulating the manipulation input unit 43, and the display control process is performed in a process of step S1. The display control process is repeatedly performed in a predetermined control cycle until the end of the display control process is instructed. A function of the controller 48 to be described below is realized by the controller 48 executing the display control program 47a.

In a process of step S1, first, the controller 48 acquires information on a direction of the vehicle from the gyro sensor 44, and acquires position information of the vehicle from the position information acquisition unit 45. Then, the controller 48 transmits information on an area in which the demand prediction information is desired to be acquired (a prediction target area) to the controller 26 via the communication network 3 based on the acquired information. Then, the controller 26 reads the demand prediction information corresponding to the prediction target area from the demand prediction information DB 22, and reads information on a state and a position of another taxis 4 (another vehicle) located in the prediction target area from the other-vehicle information DB 23. The controller 26 transmits the read information to the controller 48 via the communication network 3. Accordingly, the process of step S1 is completed, and the display control process proceeds to a process of step S2.

In the process of step S2, the controller 48 reads the map information of the prediction target area from the map information DB 41, and displays the read map information on the display unit 42 as a map screen as illustrated in FIG. 5. Further, the controller 48 displays an own vehicle icon PA indicating a direction and position of the own vehicle at a corresponding position on the map screen based on the information acquired from the gyro sensor 44 and the position information acquisition unit 45 in the process of step S1 in a superimposing manner. The controller 48 displays the demand prediction information acquired in the process of step S1 at a corresponding position on the map screen in a superimposing manner. In the map screen illustrated in FIG. 5, demand prediction icons PB1 to PB3 indicating the needed number of taxis 4 are displayed at corresponding positions on the map screen in a superimposing manner. Accordingly, the process of step S2 is completed, and the display control process proceeds to a process of step S3.

In the process of step S3, the controller 48 displays an other-vehicle icon indicating the position of the other vehicle together with a traveling direction thereof at a corresponding position on the map screen in a superimposing manner based on information on a state and position of the other vehicle acquired in the process of step S1. In this case, the controller 48 sets, to a non-display, the other-vehicle icon corresponding to another vehicle with a passenger, such as a pick-up vehicle or a rental vehicle, and sets, to a display, an other-vehicle icon corresponding to another vehicle with no passenger. In the example illustrated in FIG. 5, the other-vehicle icons PC1 to PC3 indicate other vehicles in an empty vehicle state, which travels in an arrow direction. According to such a map screen, the driver of the taxi 4 can determine whether or not a passenger desiring dispatch is caused to get in the taxi 4 in consideration of display positions of the demand prediction icons PB1 to PB3 and the display positions of the other-vehicle icons PC1 to PC3, and accurately cause the passenger desiring dispatch to get in the taxi 4. The driver can set whether or not an other-vehicle icon corresponding to another vehicle with a passenger and an other-vehicle icon corresponding to another vehicle with no passenger is to be displayed. Further, a display standard can be changed such that one other-vehicle icon is displayed for one other vehicle or one other-vehicle icon is displayed for ten other vehicles. Accordingly, the process of step S3 is completed, and a series of display control processes ends.

The server 2 may acquire the number of pedestrians near each taxi 4 as other-vehicle information using an imaging device mounted in each taxi 4, and the controller 48 may change a display form (color, size, or the like) of an icon corresponding to the taxi 4 that is in an empty vehicle state according to the number of nearby pedestrians. Further, not only the icon indicating the taxi 4 but also an icon indicating a vehicle classified according to a type of industry may be displayed on the map screen illustrated in FIG. 5. Further, the server 2 may acquire information such as a travel history, a driving history, a boarding record, and a continuous empty vehicle time of each taxi 4 as the other-vehicle information, and score each taxi 4 using the acquired other-vehicle information.

Further, the controller 48 may change the display form of the icon corresponding to the taxi 4 in the empty vehicle state according to a scoring value.

Further, on the display screen illustrated in FIG. 5, a main user interface 42a is disposed in an integrated manner on the right side of the display screen, and a user interface 42b of a manipulation system is disposed below the display screen in order to improve ease of a manipulation of a driver of a right-hand drive vehicle. Here, the user interface 42a includes an icon 42c that is manipulated when event information in the vicinity is confirmed, an icon (a display mode change user interface) 42d that is manipulated when a display mode is changed, and an icon 42e that is used for an expansion and reduction manipulation of the map screen is included. Further, the user interface 42b includes a setting button 42f, and an icon 42g that is used for a manipulation of a demand prediction time. However, in a left-hand drive vehicle, it is assumed that a setting can be changed and the user interfaces 42a can be disposed in an integrated manner on the left side of the display screen.

Further, in the embodiment, it is possible to change a display mode of the map screen by manipulating an icon 42d. That is, in a default setting illustrated in FIG. 6A, the map screen is updated in conjunction with the position information of the taxi 4 acquired by the position information acquisition unit 45, and a direction of the map screen is changed according to the direction of the taxi 4 detected by the gyro sensor 44. On the other hand, when the driver taps the icon 42d once, a setting illustrated in FIG. 6B is obtained, the map screen is updated in conjunction with the position information of the taxi 4 acquired by the position information acquisition unit 45, and the direction of the map screen is fixed with a north direction set to the upper side. Then, when the driver taps the icon 42d one more time, a setting illustrated in FIG. 6C is obtained, the map screen is not updated in conjunction with the position information of the taxi 4 acquired by the position information acquisition unit 45, and the map screen is rotatable with the north direction set to the upper side. When the driver taps the icon 42d once again, the setting returns to a setting illustrated in FIG. 6A.

Although the embodiment to which the disclosure made by the present inventors has been applied has been described, additional effects or modification examples can be easily derived by those skilled in the art. Broader aspects of the disclosure are represented as described above and are not limited to the specific details and representative embodiment described above. Accordingly, various changes may be made without departing from the spirit or scope of the general concept of the disclosure defined by the appended claims and equivalents thereof.

What is claimed is:

1. A demand prediction information display control method that is executed by a demand prediction information display control device, the demand prediction information display control method comprising:
displaying demand prediction information and an icon indicating a position of a taxi on a map screen in a superimposing manner;
setting, to a non-display, an icon corresponding to a taxi with a passenger; and
displaying, with a traveling direction of the taxi, an icon corresponding to a taxi with no passenger.

2. The demand prediction information display control method according to claim 1, wherein the demand prediction information display control device changes a display form of the icon corresponding to the taxi with no passenger according to the number of nearby pedestrians.

3. A demand prediction information display control device comprising:
a memory; and
a processor having hardware, the processor being configured to
display demand prediction information and an icon indicating a position of a taxi on a map screen in a superimposing manner,
set, to a non-display, an icon corresponding to a taxi with a passenger, and
display, with a traveling direction of the taxi, an icon corresponding to a taxi with no passenger.

4. The demand prediction information display control device according to claim 3, wherein the processor is configured to change a display form of the icon corresponding to the taxi with no passenger according to the number of nearby pedestrians.

5. A non-transitory recording medium storing a demand prediction information display control program that causes a demand prediction information display control device to execute a process comprising:
displaying demand prediction information and an icon indicating a position of a taxi on a map screen in a superimposing manner;
setting, to a non-display, an icon corresponding to a taxi with a passenger; and
displaying, with a traveling direction of the taxi, an icon corresponding to a taxi with no passenger.

6. The non-transitory recording medium according to claim 5, wherein the process further comprises changing a display form of the icon corresponding to the taxi with no passenger according to the number of nearby pedestrians.
